(19) United States
(12) Patent Application Publication
(10) Pub. No.: US 2025/0340445 A1
(43) Pub. Date: Nov. 6, 2025

(54) SILICA PARTICLE MATERIAL AND METHOD FOR PRODUCING SAME, AND ORGANIC MATERIAL COMPOSITION

(71) Applicant: ADMATECHS CO., LTD., Miyoshi-shi (JP)

(72) Inventors: Kensuke KUZUHARA, Miyoshi-shi (JP); Keisuke KURITA, Miyoshi-shi (JP); Yuki ARAI, Miyoshi-shi (JP)

(73) Assignee: ADMATECHS CO., LTD., Miyoshi-shi (JP)

(21) Appl. No.: 19/266,397

(22) Filed: Jul. 11, 2025

Related U.S. Application Data
(63) Continuation of application No. PCT/JP2023/000832, filed on Jan. 13, 2023.

(51) Int. Cl. C01B 33/193

(52) U.S. Cl. CPC C01B 33/193; C01P 2004/03; C01P 2004/51; C01P 2006/12

(57) ABSTRACT

By controlling the proportion of particles having specific particle diameters, fluidity became high, and filling ability was improved. A silica particle material of the present disclosure has a D50 of 0.8 μm to 2.5 μm and a D90/D10 of 2.0 or higher. In 0.35 μL of a liquid dispersion in which 1 mass % of the silica particle material is dispersed in methyl ethyl ketone (MEK), the number of particles of 3 μm or larger is 50 or less, the number of particles of 2 μm or larger and smaller than 3 μm is 1000 or more, and the number of particles of 1 μm or larger and smaller than 2 μm is 10000 or more. A slurry composition in which 75 mass % of the silica particle material is dispersed in an epoxy resin has a viscosity of 10000 Pa·s or lower at a shear rate of 1.0/s.

### CROSS REFERENCE TO RELATED APPLICATIONS

The present application is a Continuation application of International Application No. PCT/JP2023/000832, filed Jan. 13, 2023, which is incorporated herein by reference.

### TECHNICAL FIELD

The present disclosure relates to a silica particle material and a method for producing the same, and an organic material composition.

### BACKGROUND ART

In recent years, electronic devices have been becoming increasingly dense and precise. Thus, coarse particles are required to be removed also from silica particle materials to be used as, for example, fillers of sealing materials for semiconductors (Patent Literature 1).

In addition, fillers of sealing materials are required to have low coefficients of thermal expansion (CTE), and the proportion of the fillers is required to be high.

### CITATION LIST

### Patent Literature

Patent Literature 1: JP2016-079278 (A)

### SUMMARY OF INVENTION

### Technical Problem

In view of the above circumstances, an object to be achieved by the present disclosure is to provide: a silica particle material that has few coarse particles and that allows the filling rate thereof in an organic material such as a resin to be high; and a method for producing the silica particle material. Another object to be achieved by the present disclosure is to provide an organic material composition filled with the silica particle material.

### Solution to Problem

In order to achieve the above objects, the present inventors conducted thorough studies and obtained the following findings as a result. When classification was performed in order to remove coarse particles, the coarse particles were removed with certainty, but particles that had large particle diameters and that did not need to be removed were also removed. Consequently, the average particle diameter decreased, and the proportion of particles having small particle diameters increased. Thus, increase of a filling rate in a resin material was found to become difficult. Considering this finding, the present inventors conceived of controlling the existence proportion not only of coarse particles but also of particles having small particle diameters, thereby controlling fluidity. In particular, by controlling the proportion of particles having specific particle diameters, fluidity became high, and filling ability was improved. High filling ability means that the viscosity of the silica particle material does not become excessively high even when the filling rate thereof is increased.
(1) That is, a silica particle material of the present disclosure for achieving the above objects has a D50 of 0.8 μm to 2.5 μm and a D90/D10 of 2 or higher. In 0.35 μL of a liquid dispersion in which 1 mass % of the silica particle material is dispersed in methyl ethyl ketone (MEK), the number of particles of 3 μm or larger is 50 or less, the number of particles of 2 μm or larger and smaller than 3 μm is 1000 or more, and the number of particles of 1 μm or larger and smaller than 2 μm is 10000 or more. A slurry composition in which 75 mass % of the silica particle material is dispersed in an epoxy resin has a viscosity of 10000 Pa·s or lower at a shear rate of 1.0/s.

In addition to the above features, the silica particle material may have one or more of the following features (2) to (6).
(2) The number of hollow particles of 5 μm or larger is 50/10 mg or less.
(3) The silica particle material has a specific surface area of 1.0 m²/g to 10.0 m²/g.
(4) The silica particle material has a linseed oil absorption amount of 5.0 g or lower.
(5) The silica particle material has a U content of 2.0 ppb or lower, a Th content of 5.0 ppb or lower, and an α-ray dose of 0.002 c/cm²/h or lower.
(6) The silica particle material has been subjected to surface treatment.
(7) An organic material composition of the present disclosure for achieving the above objects includes: a dispersion medium formed from at least one of an organic resin material and an organic solvent; and 80% or higher of the above silica particle material contained in the dispersion medium with a mass of an entirety of the organic material composition being regarded as a reference. In addition, the organic material composition may have the following feature (8).
(8) The dispersion medium has fluidity, and the organic material composition has a GAP permeating property of 400 seconds or shorter, the GAP permeating property being defined as a time required for permeating a gap by 20 mm from one end of the gap, the gap having been horizontally formed with two glass slides being opposed to each other at a predetermined interval of 20 μm.
(9) A method for producing a silica particle material of the present disclosure for achieving the above objects includes: a raw particle material preparation step of preparing a raw particle material containing silica as a main component; a dispersion step of dispersing the raw particle material in water or an organic solvent to obtain a liquid dispersion; and a classification step of classifying and removing coarse particles from the liquid dispersion, the classification step including a centrifugal separation step of removing coarse particles through centrifugal separation and a filtration separation step of performing filtration through two or more types of filters in descending order of opening size, the filters at least including one or more filters of 3 μm to 7 μm.

Coarse particle classification is accurately performed by removing coarse particles through wet classification in which water or an organic solvent is used. Furthermore, coarse particles are accurately and assuredly removed by combining centrifugal separation and filtration in the wet classification.

### BRIEF DESCRIPTION OF DRAWINGS

FIG. 1 shows an SEM photograph of a test sample in Example 1; and

FIG. 2 shows an SEM photograph of a test sample in Comparative Example 3.

### DESCRIPTION OF EMBODIMENTS

A silica particle material and an organic material composition according to an embodiment of the present disclosure will be described in detail below. The silica particle material according to the present embodiment may be used as some or all of fillers that fill resin compositions to be used for sealing materials, underfills, and thermal interface materials (TIMs) for semiconductors. These resin compositions will be described in the section “Organic Material Composition” (described later) in the present embodiment. A numerical range “a to b” described herein includes the lower limit “a” and the upper limit “b” in the range unless otherwise specified. Such a numerical range may be formed by arbitrarily combining the upper and lower limit values and numerical values described in Examples. Numerical values arbitrarily selected from within these numerical ranges may be used as numerical values of new upper and lower limits. The numerical values of the upper limit and the lower limit may be or do not have to be included in the range.

### (Silica Particle Material)

The silica particle material according to the present embodiment is a particle material containing silica as a main component. The phrase “containing silica as a main component” means that the particle material is partially or entirely formed from silica, and 50% or higher of the silica is contained on a mass basis with respect to the entirety of the particle material. In particular, the lower limit value of the silica content may be set to 60%, 70%, 80%, 90%, 95%, 99%, or 100%. As a containable substance other than silica, an inorganic material is preferable. In particular, a metal oxide such as alumina, titania, or zirconia is preferable. The containable substance other than silica may be contained together with the silica in the same particles or may be contained in a mixture as particles different from particles formed from the silica.

The silica particle material according to the present embodiment preferably has a U content of 2.0 ppb or lower, a Th content of 5.0 ppb or lower, and an α-ray dose of 0.002 c/cm²/h or lower. In order to decrease the U and Th contents or decrease the α-ray dose, U, Th, and other radioactive elements serving as α-ray sources are removed. The removal of the radioactive elements preferably involves removal from a raw material to be used in a melting method or a VMC method described later. In particular, as metal silicon which is a raw material to be used in the VMC method, high-purity metal silicon is preferably used.

The silica particle material according to the present embodiment preferably has a specific surface area of 1.0 m²/g to 10.0 m²/g. In particular, the specific surface area is preferably 1.5 m²/g to 7.0 m²/g and more preferably 2.0 m²/g to 4.0 m²/g. Setting of the specific surface area to be this upper limit or smaller leads to suppression of increase in viscosity at the time of dispersion in a dispersion medium. In particular, in order to set the specific surface area to fall within this range, the shape of the silica particle material is preferably set to be similar to the shapes of perfect spheres.

The silica particle material according to the present embodiment preferably has spherical shapes. In particular, the silica particle material preferably has a circularity of 0.8 or higher, 0.9 or higher, 0.95 or higher, 0.96 or higher, or 0.99 or higher. The circularity is a value calculated according to (circularity)={4π×(area)÷(perimeter)²} based on the area and the perimeter of each of particles observed in a photograph taken with an SEM. A circularity more approximate to 1 indicates that the shape of the particle is more similar to the shape of a perfect sphere. Specifically, an average value obtained through measurement of 100 particles by using an image processing device (Sysmex Corporation: FPIA-3000) is used.

The silica particle material according to the present embodiment has a D50 of 0.8 μm to 2.5 μm. The D50 is a particle diameter at which, when particles are arranged in ascending order of particle diameter, a volume resulting from accumulation becomes 50% of the entirety. The D50 is measured by using a particle size distribution measurement device of a laser diffraction type. The D50 is preferably 1.0 μm to 2.0 μm and further preferably 1.1 μm to 1.4 μm.

The silica particle material according to the present embodiment preferably has particle diameters that vary to a certain extent. Such a certain extent of variation allows improvement of the filling rate in a resin material or the like. Specifically, the silica particle material has a D90/D10 of 2.0 or higher, preferably 2.5 or higher, and more preferably 3.0 or higher. Meanwhile, the D90/D10 is preferably 5.0 or lower, more preferably 4.5 or lower, and further preferably 4.0 or lower.

In 0.35 μL of a liquid dispersion in which 1 mass % of the silica particle material according to the present embodiment is dispersed in methyl ethyl ketone, the number of particles of 3 μm or larger is 50 or less, the number of particles of 2 μm or larger and smaller than 3 μm is 1000 or more, and the number of particles of 1 μm or larger and smaller than 2 μm is 10000 or more.

In particular, the number of the particles of 3 μm or larger is preferably 20 or less and more preferably 10 or less. The number of the particles of 2 μm or larger and smaller than 3 μm is preferably 4000 or more and more preferably 5000 or more. The number of the particles of 1 μm or larger and smaller than 2 μm is preferably 50000 or more and more preferably 100000 or more.

Furthermore, the number of hollow particles of 5 μm or larger in 10 mg of the silica particle material is preferably 50 or less, more preferably 40 or less, and further preferably 30 or less.

The existence proportion of particles of 2 μm to 3 μm is preferably 3% or higher and more preferably 5% or higher with the volume of the entirety of the silica particle material being regarded as a reference. The existence proportion of particles of 1 μm or larger is preferably 30% or higher and more preferably 50% or higher.

A method for controlling the particle diameters is not particularly limited. For example, the control is achieved by removing coarse particles and fine particles through a classification operation or adding particles having specific particle diameters. The classification operation is exemplified by: a classification operation in which a difference in a sedimentation speed that varies according to particle diameters is utilized; and a classification operation in which sieving is performed by using a filter. Examples of the method in which the difference in the sedimentation speed is utilized include: a method that includes sedimentation by gravity with the silica particle material being left at rest; a method that includes increasing the sedimentation speed by centrifugal force through rotation; and the like. A method for producing the silica particle material according to the present embodiment described later is preferably employed.

The number of the particles is measured through an evaluation method in which an image processing device (Sysmex Corporation: FPIA-3000S) is used. First, a liquid dispersion in which the silica particle material is dispersed in MEK so as to have a concentration of 1 mass % is formed, the particles are individually photographed by using the image processing device, and analysis is performed. An equivalent circular diameter is used as a particle diameter.

The silica particle material according to the present embodiment has a linseed oil absorption amount of preferably 5.0 g or lower and more preferably 4.5 g or lower. A lower linseed oil absorption amount leads to a higher filling rate. In order to decrease the linseed oil absorption amount, a certain extent of variation among the particle diameters described above is necessary. The linseed oil absorption amount is a linseed oil addition amount g at which, as a result of dripping linseed oil drop by drop onto 20 g of the particle material, the particle material has been visually confirmed to have become fluidic.

The silica particle material according to the present embodiment may be subjected to surface treatment. The method for the surface treatment is not particularly limited, but preferably includes introducing an organic functional group to the surface of the silica composing the silica particle material according to the present embodiment. The organic functional group to be introduced to the surface is exemplified by a phenyl group, a phenylamino group, a vinyl group, an alkyl group, a methacrylic group, an acrylic group, a styryl group, and an epoxy group, and furthermore, an alkylene or the like may be caused to bind as a spacer. Each of these organic functional groups is caused to directly bind to silicon atoms in the surface of the silica or is caused to bind to oxygen atoms having bound to the silicon atoms. The method for introducing the organic functional group preferably includes using a silane compound. For example, a silane coupling agent, a silazane such as hexamethyldisilazane, or the like may be reacted.

The silica particle material according to the present embodiment may contain a fine particle material. The fine particle material has particle diameters of 2 nm to 100 nm. When the fine particle material is contained, the fluidity is improved. The upper limit of the particle diameters of the fine particle material is desirably 70 nm. The lower limit of the particle diameters is desirably 10 nm. Examples of the preferable upper limit of the particle diameters include 50 nm, 30 nm, and 20 nm.

The fine particle material is desirably mixed in an amount of 0.01 parts by mass to 3 parts by mass per 100 parts by mass of the silica particle material. Meanwhile, the lower limit of the amount is exemplified by 0.05 parts by mass, 0.1 parts by mass, 0.2 parts by mass, 0.3 parts by mass, and 0.5 parts by mass, and the upper limit of the amount is exemplified by 2.5 parts by mass, 2 parts by mass, and 1.5 parts by mass. These upper and lower limits may be arbitrarily combined, or one of the upper and lower limits may be employed alone.

The fine particle material preferably has a hydrophobized surface. Here, a criterion for determining that the fine particle material has a hydrophobized surface only has to be a criterion that the fine particle material has been hydrophobized as compared to the material itself composing the fine particle material.

In addition, a slurry composition in which 75 mass % of the silica particle material is dispersed in an epoxy resin has a viscosity of 10000 Pa·s or lower at a shear rate of 1.0/s. In particular, the viscosity is preferably 7500 Pa·s or lower, 5000 Pa·s or lower, 4000 Pa·s or lower, 3000 Pa·s or lower, 2000 Pa·s or lower, 1500 Pa·s or lower, 1000 Pa·s or lower, or 800 Pa·s or lower. As the epoxy resin, an epoxy resin with a model number ZX-1059 manufactured by NIPPON STEEL Chemical & Material Co., Ltd. is used. Examples of the method for decreasing the viscosity include: a method that includes smoothing the surfaces of the particles; a method that includes obtaining a particle size distribution in which large-size particles are present, the large-size particles having sizes that allow particles having smaller particle diameters than the large-size particles to enter the intervals between the large-size particles; and the like.

### (Method for Producing Silica Particle Material)

A method for producing the silica particle material according to the present embodiment includes a raw particle material preparation step, a dispersion step, a classification step, and other steps selected as necessary.

The raw particle material preparation step is a step of preparing a raw particle material containing silica as a main component. The meaning of the phrase “containing silica as a main component” is as described above.

The raw particle material preparation step is not particularly limited, but, in order to improve circularity, a means of forming inorganic particles through a melting method or a VMC method is preferably employed. The melting method is a method that includes: turning a material composing the inorganic particles into a powder through pulverization or the like; subsequently supplying the powder into flame having a temperature not lower than a melting point to melt the powder; and subsequently rapidly cooling the melt to produce silica particles having spherical shapes. By melting and liquefying the powder in the flame, the resultant melt comes to have spherical shapes by surface tension. Thereafter, by taking out the melt from the flame and rapidly cooling the melt, the melt is cooled in a state of having the spherical shapes, whereby a silica particle material having the spherical shapes is obtained. The VMC method is a method that includes: turning metal silicon composing the silica into a powder through pulverization, atomization, or the like; subsequently supplying the powder into a high-temperature atmosphere including oxygen to ignite and deflagrate the powder; and subsequently performing cooling to obtain an intended oxide. Since a reaction explosively progresses, the obtained silica is vaporized and comes to have spherical shapes in the subsequent cooling step. In a case where a compound other than silica is contained, preparation is performed by mixing the corresponding compound with the raw material.

The VMC method will be described in more detail. This method for obtaining metal oxide particles includes: combusting a combustion improver (hydrocarbon gas or the like) with a burner in an atmosphere including oxygen to form chemical flame; and supplying metal particles into the chemical flame to cause deflagration, the metal particles having such an amount as to form a dust cloud.

Actions in the VMC method will be described as follows. First, a container is filled with oxygen-containing gas as a reaction gas, and chemical flame is formed in the reaction gas. Then, the metal particles are supplied into the chemical flame to form a dust cloud having a high concentration (e.g., 500 g/m³ or higher). Consequently, the chemical flame provides thermal energy to the surfaces of the metal particles. Thus, the temperatures of the surfaces of the metal particles increase, and vapor of the metal material is spread from the surfaces of the metal particles to the surroundings. This vapor reacts with the oxygen gas and is ignited, whereby flame is generated. Heat generated by this flame further promotes vaporization of the metal particles, and the generated vapor and the oxygen gas are mixed with each other, whereby ignition propagation successively occurs. Therefore, since smaller particle diameters of the metal particles lead to a larger specific surface area and a higher reactivity, smaller particle diameters of the metal particles lead to less energy that needs to be provided.

By progression of successive ignition in this manner, the metal particles themselves are fractured and scattered to promote flame propagation. After the combustion, the generated gas is naturally cooled, whereby a cloud of metal oxide particles is formed. The obtained metal oxide particles are collected by a bag filter, an electric dust collector, or the like.

The VMC method is based on a principle of powder dust explosion. Through the VMC method, a large amount of metal oxide particles is instantly obtained. The obtained metal oxide particles have substantially perfect spherical shapes. By adjusting the particle diameters and the supply amount of the metal particles to be supplied, the temperature of the flame, and the like, the particle diameter distribution of the metal oxide particles to be obtained is adjusted. As a raw material substance, the metal particles may be used alone, or metal oxide particles may be added in addition to the metal particles. As the metal oxide particles to be supplied simultaneously, the metal oxide particles having been obtained through this method are used, whereby the purity of the metal oxide particles to be obtained is maintained. The metal particles may be subjected to surface treatment. As the surface treatment, treatment involving a reaction in which a surface treatment agent having a hydrophobic group (alkyl group or the like) is used to introduce the hydrophobic group to the surfaces may be performed.

The dispersion step is a step of dispersing the raw particle material in a dispersion medium to prepare a liquid dispersion. As the dispersion medium, water or an organic solvent may be used. The organic solvent is exemplified by: ketones such as methyl ethyl ketone and acetone; hydrocarbons such as hexane and octane; alcohols such as methanol, ethanol, and isopropyl alcohol; and aromatic hydrocarbons such as toluene and xylene. In the case of mixing these dispersion media, a mixed solvent resulting from mixing two or more of the water and these types of organic solvents is used as a dispersion medium. In a case where a slurry composition is necessary as a final silica particle material, some or all of organic solvents to be contained in a dispersion medium composing the slurry composition are preferably used as dispersion media.

The concentration of the raw particle material in the liquid dispersion is not particularly limited and is exemplified by 5 mass % to 70 mass %, 10 mass % to 55 mass %, and 15 mass % to 40 mass %. The preparation of the liquid dispersion may be performed through dispersion by using a dispersing machine of, for example, a high-pressure type such as a nozzle type or a valve type, an ultrasonic type in which an ultrasonic wave is radiated, or a stirring type.

The classification step is a step of removing coarse particles from the liquid dispersion through a classification operation. In the classification operation, a centrifugal separation step and a filtration separation step are performed in no particular order. In particular, when the centrifugal separation step is performed first, the amount of coarse particles to be removed in the filtration step is decreased, whereby the efficiency of filtration is improved.

The centrifugal separation step is a step of causing the liquid dispersion to flow along a rotating flow to generate centrifugal force, thereby removing particles having relatively large particle diameters. As a means for generating the rotating flow, a cyclone or the like is used.

The filtration separation step is a step of performing filtration through two or more types of filters in descending order of opening size to remove coarse particles. At least one of the two or more types of filters is a filter of 3 μm to 7 μm. One of the two or more types of filters is particularly preferably a filter of 3 μm.

After the coarse particles have been removed through the classification step, the following operation is performed. That is, in the case of directly obtaining a slurry composition, the amount of the dispersion medium is increased or decreased until a predetermined concentration is obtained, whereas, in the case of obtaining a dried silica particle material, the dispersion medium is removed to dry the silica particle material. The decrease of the amount of the dispersion medium and the drying may be achieved through heating or decompression. The dried silica particle material is subjected to a pulverization operation or the like to apply such a shear force as not to fracture the particles, whereby clumps are broken down.

### (Organic Material Composition)

The organic material composition according to the present embodiment includes: the above silica particle material according to the present embodiment; and a dispersion medium dispersing the silica particle material. The organic material composition according to the present embodiment contains 80% or higher of the silica particle material with the mass of the entirety of the organic material composition being regarded as a reference.

The dispersion medium is formed from at least one of an organic resin material and an organic solvent. When an organic resin material is used as the dispersion medium, the organic material composition is suitably usable as a resin composition for electronic devices, such as a sealing material, an underfill, or a substrate for semiconductor elements. When an organic solvent is used as the dispersion medium, the organic material composition is suitably usable as, for example, a slurry composition for supplying the silica particle material into a resin material.

As the organic resin material, any organic resin material is usable regardless of whether the material is a thermosetting resin or a thermoplastic resin, and an uncured organic resin material is also usable. Examples of the organic resin material include epoxy resins, silicone resins, urea resins, acrylic resins, and the like. The organic solvent is exemplified by: ketones such as methyl ethyl ketone and acetone; hydrocarbons such as hexane and octane; alcohols such as methanol and ethanol; and aromatic hydrocarbons such as toluene and xylene.

### EXAMPLES

The silica particle material and the organic material composition of the present disclosure will be described in detail on the basis of the following Examples.

### Example 1

A raw particle material (formed from silica and having a volume-average particle diameter of 2.0 μm) obtained through the VMC method was dispersed in isopropyl alcohol by using a dispersing machine of a high-pressure type, whereby a liquid dispersion (dispersion slurry) having a solid concentration of 30 mass % was obtained.

By utilizing the difference in sedimentation speed according to particle diameters in the liquid dispersion, solid coarse particles of 3 μm or larger were removed by a centrifugal separation machine.

Next, by using each of filters having opening diameters of 7 μm, 5 μm, and 3 μm, classification was performed one time. Thus, coarse particles of 3 μm or larger including hollow particles were removed, whereby a post-classification slurry composition was obtained. The post-classification slurry was dried by using a dryer to obtain a silica particle material which was then used as a test sample in this Example.

### Example 2

A sample in which 20 mass % of silica having a volume-average particle diameter of 0.3 μm was added to the silica in Example 1 with the mass of the entirety being regarded as a reference was used as a test sample in this Example. The silica having a volume-average particle diameter of 0.3 μm was silica having passed through a sieve of 1 μm (the same applies below).

### Example 3

A sample in which 40 mass % of the silica having a volume-average particle diameter of 0.3 μm was added to the silica in Example 1 with the mass of the entirety being regarded as a reference was used as a test sample in this Example.

### Example 4

A sample in which 10 mass % of silica having a particle diameter of 50 nm was added to the silica in Example 1 with the mass of the entirety being regarded as a reference was used as a test sample in this Example.

### Comparative Example 1

A sample obtained by causing silica of 0.5 μm to pass through a sieve having an opening size of 3 μm was used as a test sample in this Comparative Example.

### Comparative Example 2

The raw particle material used in Example 1 was dispersed in isopropyl alcohol, whereby a liquid dispersion (dispersion slurry) having a solid concentration of 30 mass % was obtained.

By utilizing the difference in sedimentation speed according to particle diameters in the liquid dispersion, solid coarse particles of 5 μm or larger were removed by the centrifugal separation machine.

Next, by using each of filters having opening diameters of 7 μm and 5 μm, classification was performed one time. Thus, coarse particles of 5 μm or larger including hollow particles were removed, whereby a post-classification slurry composition was obtained. The post-classification slurry was dried by using the dryer to obtain a silica particle material which was then used as a test sample in this Comparative Example.

### Comparative Example 3

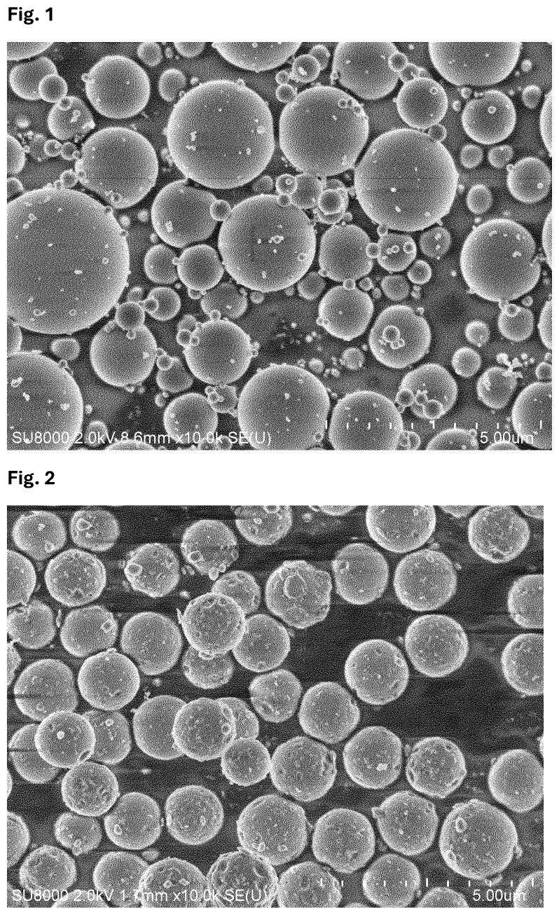

A 2-L reaction container equipped with a stirrer was set in a thermostat, and 342 g of ethanol, 184 g of water, and 204 g of 25-mass % ammonia water were put into the reaction container and were heated to 25° C. while being mixed by using the stirrer. Then, while the resultant liquid mixture was being stirred, 421 g of tetraethoxysilane was continuously added over 45 minutes. After the addition, the resultant solution was filtered to obtain silica particles which were then used as a test sample in this Comparative Example. Thereafter, the test sample was dried at 130° C. overnight and then fired at 1000° C. The firing was performed under a condition that the test sample was heated to 1000° C. over 10 hours and retained for 5 hours. Then, the test sample was cooled. The obtained silica particles had spherical shapes and had an average particle diameter of 1.5 μm. The value of D90/D10 was 1.7. An SEM photograph of each of the test sample in Example 1 and the test sample in Comparative Example 3 was taken (FIG. 1: Example 1, FIG. 2: Comparative Example 3).

### (Evaluation)

Regarding each of the test samples in the Examples and the Comparative Examples, a volume-average particle diameter (D50), a specific surface area (SSA), the numbers of particles in 0.35 μL of a 1.0-mass % MEK liquid dispersion, the number of hollow particles of 5 μm or larger in 10 mg of the corresponding silica particle material, and a linseed oil absorption amount per 20 g were measured. Furthermore, regarding each of slurry compositions in which the respective test samples in the Examples and the Comparative Examples were dispersed in an epoxy resin material such that the test sample contents became 75 mass %, a viscosity at a shear rate of 1.0/s and a GAP permeating property were measured. The results of these measurements are indicated in Table 1. Methods for the measurements will be described below.

### Volume-Average Particle Diameter (D50) and Particle Size Distribution

The D50 and a particle size distribution were obtained as follows. That is, the D50 was measured as a median diameter through a laser diffraction/scattering method by using LA750 manufactured by HORIBA, Ltd., and the particle size distribution was expressed in percentage on a mass basis. However, the particle size distribution in Comparative Example 3 was substantially monodisperse, and thus is not described.

### Specific Surface Area (SSA)

Measurement was performed at a normal temperature (25° C.) through the BET method by using nitrogen gas.

### Numbers of Particles in 0.35 μL of 1.0-Mass % MEK Liquid Dispersion

The number of particles having particle diameters in a range of 1 μm or larger and smaller than 2 μm, the number of particles having particle diameters in a range of 2 μm or larger and smaller than 3 μm, and the number of particles having particle diameters in a range of 3 μm or larger were measured through the method described in the present embodiment.

### Number of Hollow Particles of 5 μm or Larger in 10 mg of Silica Particle Material

The number of hollow particles was measured by using an image analysis device (JASCO International Co., Ltd.: IF3200).

Determination as to whether or not the particles being analyzed were hollow particles was performed according to a difference in appearance. Hollow particles had appearances prominently different from those of solid particles, and thus distinguishment therebetween was easily achieved.

### Linseed Oil Absorption Amount Per 20 g

The linseed oil absorption amount was measured as a linseed oil addition amount (g) at which, as a result of dripping linseed oil drop by drop onto 20 g of each of the test samples, the test sample was visually confirmed to have become fluidic.

### Viscosity at Shear Rate of 1.0/s

Slurry compositions in which the respective test samples in the Examples and Comparative Examples were mixed and dispersed in an epoxy resin such that the test sample contents became 75 mass % were prepared. As the epoxy resin, an epoxy resin with a model number ZX-1059 manufactured by NIPPON STEEL Chemical & Material Co., Ltd. was used. A viscosity of each of the obtained slurry compositions at a shear rate of 1.0/s was measured. The measurement of the viscosity was performed by using a rheometer-viscometer (ARES-G2 manufactured by TA Instruments).

### GAP Permeating Property

The GAP permeating property was evaluated as follows. That is, gap cover glass which was manufactured by Matsunami Glass Ind., Ltd. and in which a glass slide was placed above another glass slide with a gap of 20 μm therebetween was used, and each of the filler-containing compositions in the Examples and the Comparative Examples was evenly placed on one sample-dripping side (short side) of the gap cover glass by using a syringe. The time that the filler-containing composition took to advance (over 20.0 mm) and reach the opposite side from the time point of the placement was measured.

TABLE 1

| | Particle size distribution | | | | |
|---|---|---|---|---|---|
| | | | 1 μm or | 2 μm or | Specific |
| | | | larger and | larger and | surface |
| | | | smaller than | smaller than | area |
| | D50 | D90/D10 | 2 μm (%) | 3 μm (%) | (m²/g) |
| Example 1 | 1.3 | 2.7 | 65.6 | 5.3 | 2.9 |
| Example 2 | 1.2 | 3.6 | 59.2 | 9.1 | 3.1 |
| Example 3 | 1.0 | 4.9 | 50.9 | 8.1 | 6.5 |
| Example 4 | 1.2 | 3.1 | 63.7 | 9.7 | 8.9 |
| Comparative | 0.5 | 2.7 | 2.0 | 0.0 | 5.0 |
| Example 1 | | | | | |
| Comparative | 1.4 | 4.7 | 71.6 | 2.1 | 4.3 |
| Example 2 | | | | | |
| Comparative | 1.1 | 1.8 | — | — | 2.7 |
| Example 3 | | | | | |

| | | | | Hollow | Coarse |
|---|---|---|---|---|---|
| | | | | particles | particles |
| | | | | of 5 μm | of 5 μm |
| | Coarse particles (particles) | | | or larger | or larger |
| | 1 to | 2 to | 3 μm or | (particles/ | (particles/ |
| | 2 μm | 3 μm | larger | 10 mg) | 10 g) |
| Example 1 | 216604 | 6069 | 2 | 14 | Less than 10 |
| Example 2 | 173296 | 4855 | 2 | 35 | Less than 10 |
| Example 3 | 72788 | 4293 | 15 | 41 | Less than 10 |
| Example 4 | 77148 | 5129 | 47 | 21 | Less than 10 |
| Comparative | 5178 | 5 | 0 | 18 | Less than 10 |
| Example 1 | | | | | |
| Comparative | 75674 | 18494 | 4399 | 88 | 100 or more |
| Example 2 | | | | | |
| Comparative | 69453 | 14 | 0 | — | — |
| Example 3 | | | | | |

| | Linseed | Viscosity | GAP | | |
|---|---|---|---|---|---|
| | oil | (75 wt | permeating | | |
| | absorption | %, 1.0 | property | U | Th |
| | amount | s−1) | (s) | ppb | ppb |
| Example 1 | 4.5 | 2500 | 300 | Lower | Lower |
| | | | | than | than |
| | | | | 0.1 | 0.2 |
| Example 2 | 3.8 | 1200 | 250 | Lower | Lower |
| | | | | than | than |
| | | | | 0.1 | 0.2 |
| Example 3 | 3.6 | 3500 | 320 | Lower | Lower |
| | | | | than | than |
| | | | | 0.1 | 0.2 |
| Example 4 | 3.5 | 500 | 350 | 0.2 | 15.18 |
| Comparative | 5.4 | Unmea- | 420 | Lower | Lower |
| Example 1 | | surable | | than | than |
| | | | | 0.1 | 0.2 |
| Comparative | 4.1 | 2200 | 460 | Lower | Lower |
| Example 2 | | | | than | than |
| | | | | 0.1 | 0.2 |
| Comparative | 6.5 | Unmea- | 320 | — | — |
| Example 3 | | surable | | | |

As is obvious from the table, in each of the test samples in Examples 1 to 4, the number of particles of 2 μm or larger and smaller than 3 μm was 1000 or more (particularly 3000 or more), and furthermore, the number of particles of 1 μm or larger and smaller than 2 μm was 10000 or more. Thus, these Examples were found to exhibit high fluidities and allow improvement of filling abilities. Therefore, high filling contents of 80% or higher were obtained, and the viscosities were moderate. In addition, the quantity of coarse particles of 3 μm or larger was five or less, i.e., sufficiently small.

In the test sample in Comparative Example 1, almost all of particles of 2 μm or larger were removed and the viscosity became unmeasurably high, as a result of performing dry classification. In addition, the linseed oil absorption amount of this test sample also had a large value. In addition, in the test sample in Comparative Example 1, the D50 had a small value of 0.5 μm, and thus the D50 being outside the range of 1.0 μm or larger and 1.3 μm or smaller unlike in the test samples in Examples 1 to 4 is also inferred to be a factor of the high viscosity.

In Comparative Example 2, the viscosity was low, but the number of coarse particles having particle diameters of 3 μm or larger was large. Since a large number of particles of 3 μm or larger were present, permeation into a narrow gap was difficult, whereby the GAP permeating property was poor.

In Comparative Example 3, even though no particular classification was performed, the existence quantity of coarse particles of 3 μm or larger was small. However, in Comparative Example 3, the number of particles of 2 μm or larger and smaller than 3 μm was small, the filling rate was low, and the viscosity was high. In addition, in Comparative Example 3, the linseed oil absorption amount was also high. In addition, comparison between FIG. 1 and FIG. 2 leads to a finding that the smoothness of the surfaces of the particles differed since the production method differed. The test sample in Comparative Example 3 had uneven surfaces, and thus the test sample in Example 1 had smoother surfaces. This is considered to be the reason why the test sample in Comparative Example 3 had a higher viscosity than the test sample in Example 1. Here, the surfaces may be determined to be smooth in a case where the viscosity measured through the above viscosity measurement falls within the corresponding range in the present disclosure.

1. A silica particle material, wherein
the silica particle material has a D50 of 0.8 μm to 2.5 μm and a D90/D10 of 2.0 or higher,
in 0.35 μL of a liquid dispersion in which 1 mass % of the silica particle material is dispersed in methyl ethyl ketone, the number of particles of 3 μm or larger is 50 or less, the number of particles of 2 μm or larger and smaller than 3 μm is 1000 or more, and the number of particles of 1 μm or larger and smaller than 2 μm is 10000 or more, and
a slurry composition in which 75 mass % of the silica particle material is dispersed in an epoxy resin has a viscosity of 10000 Pa·s or lower at a shear rate of 1.0/s.

2. The silica particle material according to claim 1, wherein the number of hollow particles of 5 μm or larger is 50/10 mg or less.

3. The silica particle material according to claim 1, wherein the silica particle material has a specific surface area of 1.0 m²/g to 10.0 m²/g.

4. The silica particle material according to claim 2, wherein the silica particle material has a specific surface area of 1.0 m²/g to 10.0 m²/g.

5. The silica particle material according to claim 1, wherein the silica particle material has a linseed oil absorption amount of 5.0 g/20 g or lower.

6. The silica particle material according to claim 2, wherein the silica particle material has a U content of 2.0 ppb or lower, a Th content of 5.0 ppb or lower, and an α-ray dose of 0.002 c/cm²/h or lower.

7. The silica particle material according to claim 1, wherein the silica particle material has been subjected to surface treatment.

8. The silica particle material according to claim 2, wherein the silica particle material has been subjected to surface treatment.

9. An organic material composition comprising:
a dispersion medium formed from at least one of an organic resin material and an organic solvent; and
80% or higher of the silica particle material according to claim 1 contained in the dispersion medium with a mass of an entirety of the organic material composition being regarded as a reference.

10. An organic material composition comprising:
a dispersion medium formed from at least one of an organic resin material and an organic solvent; and
80% or higher of the silica particle material according to claim 2 contained in the dispersion medium with a mass of an entirety of the organic material composition being regarded as a reference.

11. The organic material composition according to claim 9, wherein
the dispersion medium has fluidity, and
the organic material composition has a GAP permeating property of 400 seconds or shorter, the GAP permeating property being defined as a time required for permeating a gap by 20.0 mm from one end of the gap, the gap having been horizontally formed with two glass slides being opposed to each other at a predetermined interval of 20 μm.

12. The organic material composition according to claim 10, wherein
the dispersion medium has fluidity, and
the organic material composition has a GAP permeating property of 400 seconds or shorter, the GAP permeating property being defined as a time required for permeating a gap by 20.0 mm from one end of the gap, the gap having been horizontally formed with two glass slides being opposed to each other at a predetermined interval of 20 μm.

13. A method for producing a silica particle material, the method comprising:
a raw particle material preparation step of preparing a raw particle material containing silica as a main component;
a dispersion step of dispersing the raw particle material in water or an organic solvent to obtain a liquid dispersion; and
a classification step of classifying and removing coarse particles from the liquid dispersion, the classification step including a centrifugal separation step of removing coarse particles through centrifugal separation and a filtration separation step of performing filtration through two or more types of filters in descending order of opening size, the filters at least including one or more filters of 3 μm to 7 μm.
